(19) United States
(12) Patent Application Publication
(10) Pub. No.: US 2019/0073825 A1
(43) Pub. Date: Mar. 7, 2019

(54) ENHANCING DEPTH SENSOR-BASED 3D GEOMETRY RECONSTRUCTION WITH PHOTOGRAMMETRY

(71) Applicant: VanGogh Imaging, Inc., McLean, VA (US)

(72) Inventors: Ken Lee, Fairfax, VA (US); Huy Bui, McLean, VA (US)

(21) Appl. No.: 16/118,894

(22) Filed: Aug. 31, 2018

Related U.S. Application Data
(60) Provisional application No. 62/553,380, filed on Sep. 1, 2017.

(51) Int. Cl. G06T 17/20; G06T 19/20

(52) U.S. Cl. CPC G06T 17/20; G06T 7/579; G06T 19/20

(57) ABSTRACT

Described are methods and systems for enhancing depth sensor-based 3D geometry reconstruction with photogrammetry. A 3D sensor captures scans of a physical object, including related pose information and HD images corresponding to each scan. For each scan, a computing device generates an initial 3D model of the physical object, the initial model having missing sections. The computing device detects the missing sections in a 3D point cloud associated with the initial model and projects the missing sections in the point cloud to a corresponding HD image. The computing device generates image segments of the corresponding HD image that match the missing sections in the point cloud, generates a point cloud structure for each of the image segments of the corresponding HD image, and merges the initial model and the generated point cloud structures to generate a final 3D model with the missing sections filled in.

### RELATED APPLICATIONS

This application claims priority to U.S. Provisional Patent Application No. 62/553,380, filed on Sep. 1, 2017, which is incorporated herein by reference.

### TECHNICAL FIELD

This subject matter of this application relates generally to methods and apparatuses, including computer program products, for enhancing depth sensor-based 3D geometry reconstruction with photogrammetry.

### BACKGROUND

3D scanners (e.g., RGB+depth sensors) are used increasingly to generate digital 3D models of objects for animation, virtual reality, and e-commerce applications. In one example, computing devices track the pose of the RBG+depth sensor and then combine multiple point clouds derived from the depth map to generate the 3D model.

However, some objects have surfaces or thin features that cannot be accurately captured by the RGB+depth sensor. For example, a black surface of an object would be seen as ‘blank’ by a depth sensor—which would result in a generated 3D model having a hole where the ‘blank’ surface was captured. FIG. 1A is an example of an object 102a (i.e., a plastic figurine) with a black surface on the upper portion. When traditional 3D capture and modeling techniques are used to generate a 3D model of the figurine 102a, the resulting model (shown in FIG. 1B) has a hole (e.g., missing points) in the area of the black surface.

### SUMMARY

Therefore, what is needed are methods and systems for enhancing depth sensor-based 3D geometry reconstruction with photogrammetry to augment and fill in such missing sections of 3D models that result from surfaces or features that are not sufficiently captured by RBG+depth sensors. The methods and systems described herein provide the advantage of generating more complete 3D models from images of an object, captured with RBG+depth sensors, that may have surfaces or features that result in holes in the originally-generated 3D model. The methods and systems enhance 3D reconstruction by capturing RGB images during the scanning process. The RGB images plus the corresponding pose information generated by the tracking process are used to estimate the depth of the pixels on the image. These ‘depth by triangulation’ points can then be used to augment and fill in the missing sections of the object.

The invention, in one aspect, features a computerized method of enhancing depth sensor-based 3D geometry reconstruction with photogrammetry. A 3D sensor coupled to a computing device captures one or more 3D scans of a physical object, including related pose information of the physical object, and one or more HD images corresponding to each 3D scan. For each 3D scan: the computing device generates an initial 3D model of the physical object using the 3D scan, the initial 3D model having one or more missing sections. The computing device detects the one or more missing sections in a 3D point cloud associated with the initial 3D model. The computing device projects the one or more missing sections in the 3D point cloud to a corresponding HD image for the 3D scan. The computing device generates one or more image segments of the corresponding HD image that match the one or more missing sections in the 3D point cloud. The computing device generates a 3D point cloud structure for each of the one or more image segments of the corresponding HD image. The computing device merges the initial 3D model and the generated 3D point cloud structures to generate a final 3D model with the one or more missing sections filled in.

The invention, in one aspect, features a system for enhancing depth sensor-based 3D geometry reconstruction with photogrammetry. The system comprises a 3D sensor coupled to a computing device. The 3D sensor captures one or more 3D scans of a physical object, including related pose information of the physical object, and one or more HD images corresponding to each 3D scan. For each 3D scan: the computing device generates an initial 3D model of the physical object using the 3D scan, the initial 3D model having one or more missing sections. The computing device detects the one or more missing sections in a 3D point cloud associated with the initial 3D model. The computing device projects the one or more missing sections in the 3D point cloud to a corresponding HD image for the 3D scan. The computing device generates one or more image segments of the corresponding HD image that match the one or more missing sections in the 3D point cloud. The computing device generates a 3D point cloud structure for each of the one or more image segments of the corresponding HD image. The computing device merges the initial 3D model and the generated 3D point cloud structures to generate a final 3D model with the one or more missing sections filled in.

The techniques described herein can use the object detection, reconstruction, and 3D model generation techniques as described in U.S. Pat. Nos. 9,710,960 and 9,715,761, and U.S. patent application Ser. Nos. 14/849,172, 15/441,166, 15/596,590, and 15/638,278, each of which is incorporated herein by reference.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A is an example of an object with a black surface.

FIG. 1B is an example of a 3D model with a large hole.

FIG. 1C is a block diagram of a system for generating a textured three-dimensional (3D) model of an object represented in a scene.

FIG. 2 is a flow diagram of a method of enhancing depth sensor-based 3D geometry reconstruction with photogrammetry.

FIG. 3 is a flow diagram of a method of generating 3D geometry using Structure-for-Motion.

FIG. 4 is a diagram of a 2-view geometry case.

### DETAILED DESCRIPTION

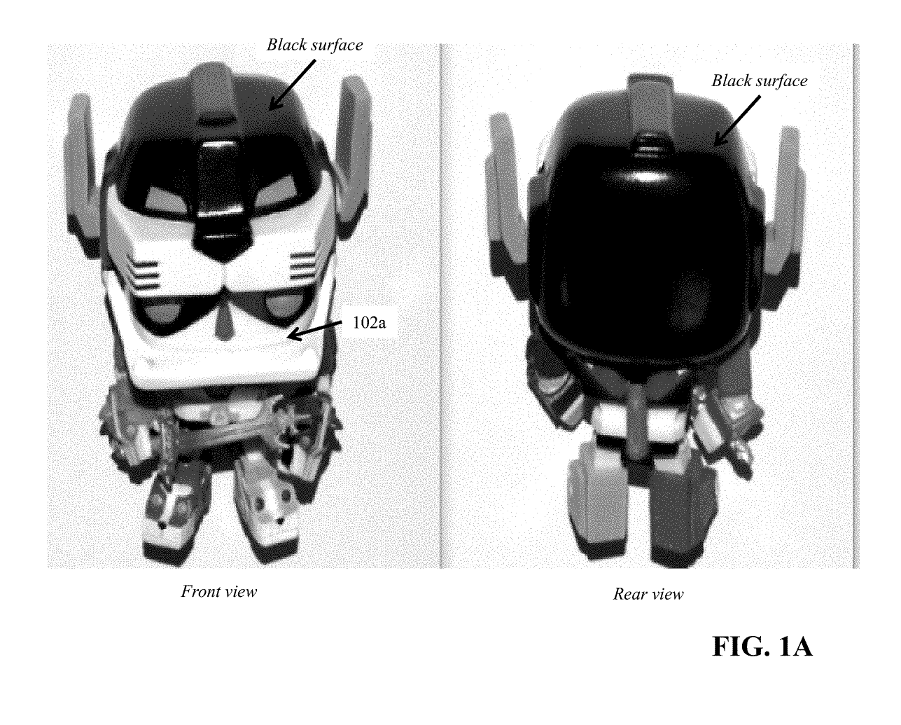

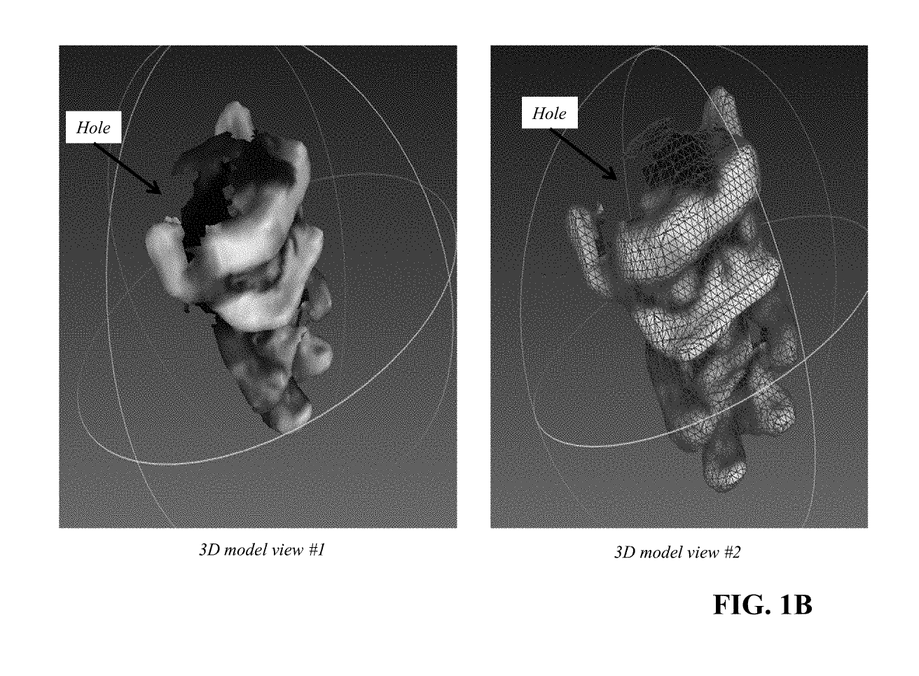

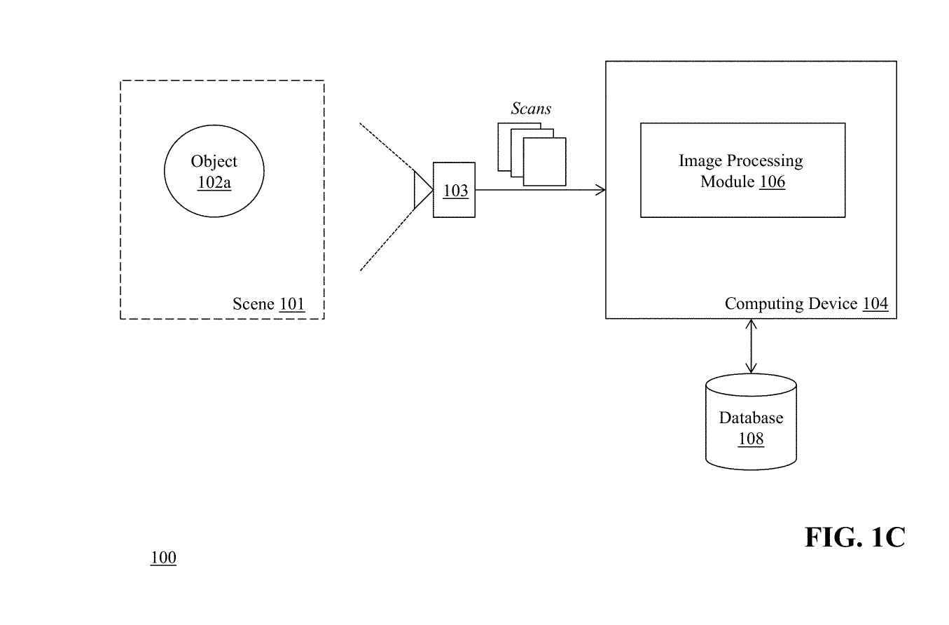

FIG. 1C is a block diagram of a system 100 for generating a textured three-dimensional (3D) model of an object represented in a scene. Certain embodiments of the systems and methods described in this application utilize the object recognition and modeling techniques as described in U.S. Pat. No. 9,715,761, titled “Real-Time 3D Computer Vision Processing Engine for Object Recognition, Reconstruction, and Analysis,” and as described in U.S. patent application Ser. No. 14/849,172, titled “Real-Time Dynamic Three-Dimensional Adaptive Object Recognition and Model Reconstruction,” both of which are incorporated herein by reference. Certain embodiments of the systems and methods described in this application further utilize the 3D photogrammetry techniques as described in U.S. patent application Ser. No. 15/596,590, titled “3D Photogrammetry,” published as U.S. Patent Application Publication No. 2017/0337726, which is also incorporated herein by reference. Such methods and systems are available by implementing the Starry Night plug-in for the Unity 3D development platform, available from VanGogh Imaging, Inc. of McLean, Va.

The system includes a sensor 103 coupled to a computing device 104. The computing device 104 includes an image processing module 106. In some embodiments, the computing device can also be coupled to a data storage module 108, e.g., used for storing certain 3D models, color images, and other data as described herein.

The sensor 103 is positioned to capture images (e.g., color images) of a scene 101 which includes one or more physical objects (e.g., object 102a). Exemplary sensors that can be used in the system 100 include, but are not limited to, 3D scanners, RGB+depth sensors, digital cameras, and other types of devices that are capable of capturing depth information of the pixels along with the images of a real-world object and/or scene to collect data on its position, location, and appearance. In some embodiments, the sensor 103 is embedded into the computing device 104, such as a camera in a smartphone, for example.

The computing device 104 receives images (also called scans) of the scene 101 from the sensor 103 and processes the images to generate 3D models of objects (e.g., object 102a) represented in the scene 101. The computing device 104 can take on many forms, including both mobile and non-mobile forms. Exemplary computing devices include, but are not limited to, a laptop computer, a desktop computer, a tablet computer, a smart phone, augmented reality (AR)/virtual reality (VR) devices (e.g., glasses, headset apparatuses, and so forth), an internet appliance, or the like. It should be appreciated that other computing devices (e.g., an embedded system) can be used without departing from the scope of the invention. The mobile computing device 102 includes network-interface components to connect to a communications network. In some embodiments, the network-interface components include components to connect to a wireless network, such as a Wi-Fi or cellular network, in order to access a wider network, such as the Internet.

The computing device 104 includes an image processing module 106 configured to receive images captured by the sensor 103 and analyze the images in a variety of ways, including detecting the position and location of objects represented in the images and generating 3D models of objects in the images. The image processing module 106 is a hardware and/or software module that resides on the computing device 104 to perform functions associated with analyzing images capture by the scanner, including the generation of 3D models based upon objects in the images. In some embodiments, the functionality of the image processing module 106 is distributed among a plurality of computing devices. In some embodiments, the image processing module 106 operates in conjunction with other modules that are either also located on the computing device 104 or on other computing devices coupled to the computing device 104. An exemplary image processing module is the Starry Night plug-in for the Unity 3D engine or other similar libraries, available from VanGogh Imaging, Inc. of McLean, Va. It should be appreciated that any number of computing devices, arranged in a variety of architectures, resources, and configurations (e.g., cluster computing, virtual computing, cloud computing) can be used without departing from the scope of the invention.

The data storage module 108 is coupled to the computing device 104, and operates to store data used by the image processing module 106 during its image analysis functions. The data storage module 108 can be integrated with the server computing device 104 or be located on a separate computing device.

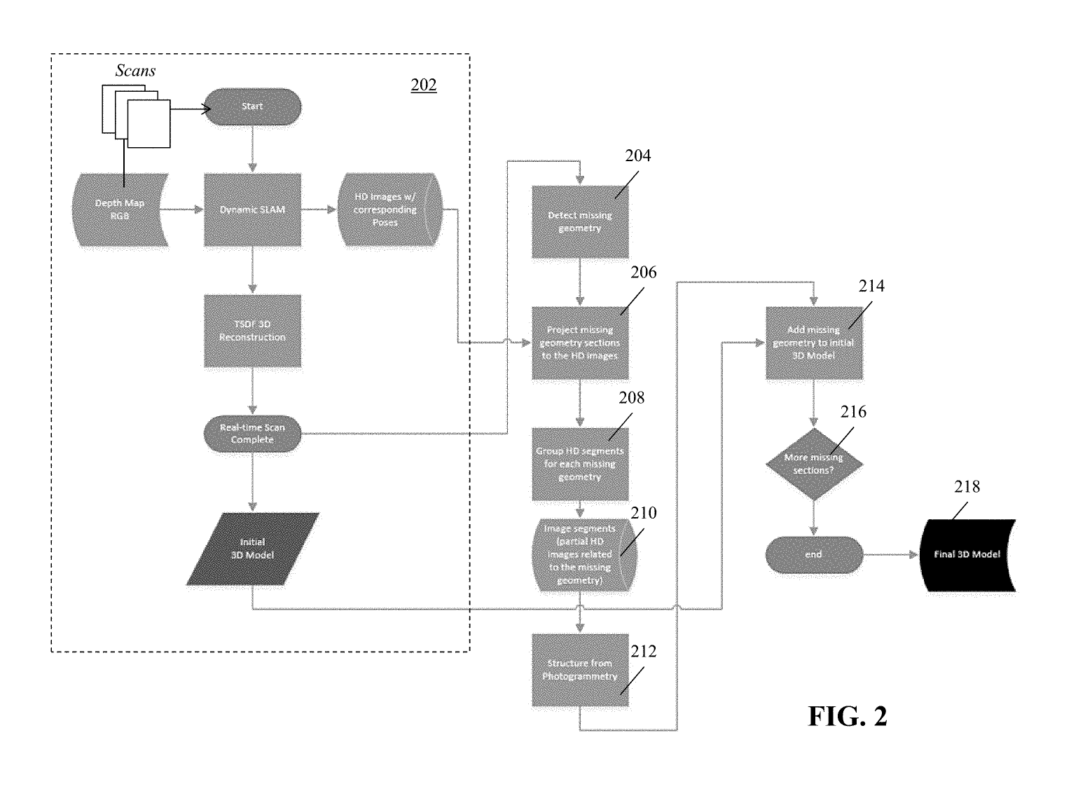

FIG. 2 is a flow diagram of a method of enhancing depth sensor-based 3D geometry reconstruction with photogrammetry, using the system 100 of FIG. 1C. As shown in FIG. 2, section 202, the sensor 103 captures a plurality of scans of the object 102a in the scene 101 and transmits the scans to the image processing module 106 of server computing device as input to start the method. It should be appreciated that the scan can comprise an HD image of the object 102a and scene 101, along with a depth map and corresponding pose information. Generally, it is preferable for the sensor 103 to capture approximately 30-50 HD images for a given object (e.g., as the sensor 103 moves around the object 102a and/or the object moves in front of the sensor). The image processing module 106 performs a dynamic SLAM process (as described in U.S. Pat. No. 9,715,761, titled “Real-Time 3D Computer Vision Processing Engine for Object Recognition, Reconstruction, and Analysis,” and as described in U.S. patent application Ser. No. 14/849,172, titled “Real-Time Dynamic Three-Dimensional Adaptive Object Recognition and Model Reconstruction,” to capture and process the incoming scans into HD images with corresponding poses. The image processing module 106 also performs Truncated Signed Distance Function (TDSF) 3D reconstruction on the incoming data captured by the sensor 103 to complete the 3D point cloud of the object 102a in the scan and to generate the initial 3D model.

Once the image processing module 106 has generated the initial 3D model and the HD images with corresponding pose information, the module 106 can proceed to enhance the 3D model using photogrammetry based upon the HD images and pose information as described below.

As shown in FIG. 2, the module 106 detects (204) missing geometry sections (e.g., holes) in the 3D point cloud, and uses the captured HD images and pose information to segment out (206) the missing geometry sections to the HD images. The module 106 then groups (208) image segments (i.e., portions of the HD images—not the entire images—that correspond to the missing geometry sections) and generates these HD image portions (210) for storage in database 108. Next, the module 106 generates 3D structure from photogrammetry (212) applied to the partial HD images, where the 3D structure corresponds to the portion of the object captured in the HD image portion. Then, the module 106 merges (214) the 3D structure generated via photogrammetry with the initial 3D model (as generated in FIG. 2, section 202) to produce an enhanced 3D model with the missing section filled in. The module 106 determines (216) whether there are any other missing geometry sections in the 3D model and, if so, performs the above process on further HD images to generate 3D structure for those missing sections. Once the module 106 is finished, the module 106 generates (218) a final 3D model with the holes from the initial 3D model filled in—resulting in a more robust and accurate 3D model.

One approach to generating the 3D geometry structure is called ‘Structure from Motion,’ which is described in detail below. It should be appreciated, however, that other means of generating 3D structure (such as stereo) can also be used.

Generation of 3D Geometry from Color Images Using Structure from Motion Approach

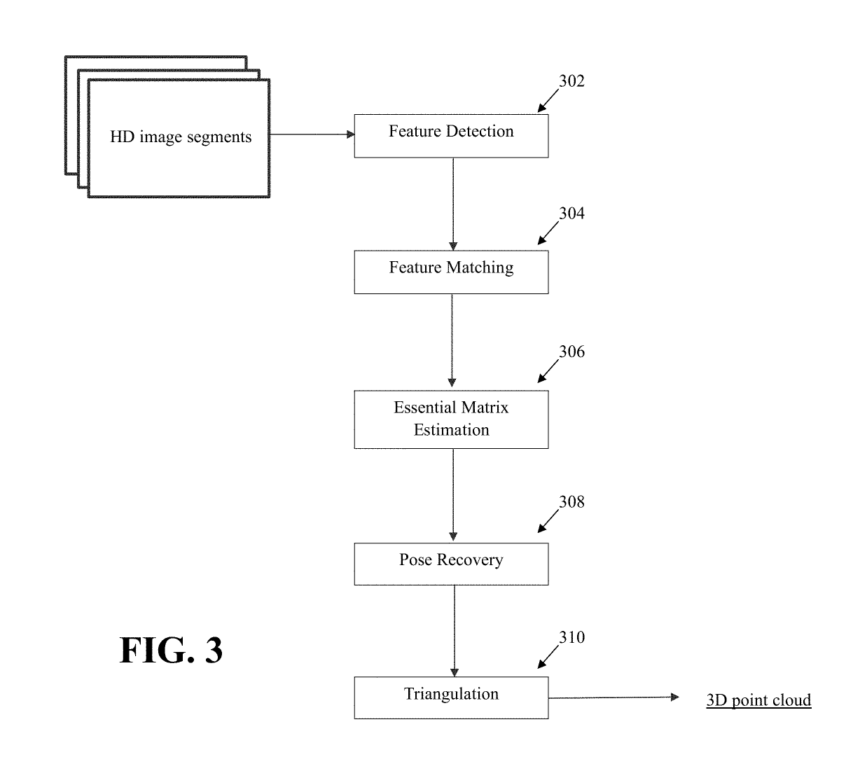

To generate 3D geometry from collections of 2D image segments, the image processing module 106 uses a ‘Structure-from-Motion’ (SfM) approach. FIG. 3 is a flow diagram of a method of generating 3D geometry using Structure-for-Motion. First, the image processing module 106 extracts (302) 2D keypoints and their corresponding descriptors from each image segment. Then, the image processing module 106 matches (304) features between pairs of HD segments that see the same part of the object. Given the feature matching results, the module 106 estimates (306) the essential matrices that relate HD segments in each pair, and the module 106 recovers (308) the 3D poses of the segments. Then, the module 106 triangulates (310) pairs of matched keypoints to generate the 3D points on the model.

To process a collection of segments, first the process is bootstrapped using two HD segments to generate initial 3D points. The 3D points are used to match with the next HD segment and are augmented with new 3D points generated using the same process. This process is repeated until all HD segments are processed.

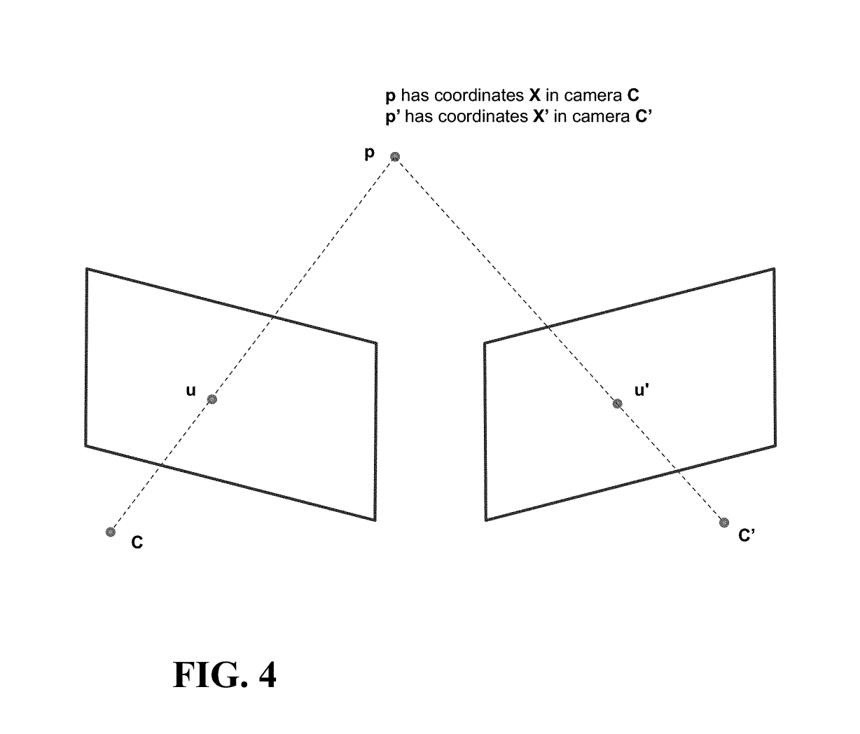

The SfM approach is based on the idea of multiple view geometry. For example, let's consider the 2-view geometry case as shown in FIG. 4. Let X′ be a Euclidean point in the coordinate system of camera C′. The position of the same point in the coordinate system of another camera C will be:

X=RX′+T

where R is a 3-by-3 rotation matrix and T is a 3-vector. If both sides are pre-multiplied by X^{T}[T]ₓ then we have

X^{T}[T]ₓRX′=EX′=0

where E˜[T]ₓR is called the essential matrix and [T]ₓ is the cross product matrix. E depends only on R and T and is defined up to a scale factor. Thus it has 5 parameters.

Let K and K′ be the projection matrix of camera C and C′, respectively. Let u=KX and u′=K′X′ be the 2D projection of the 3D point onto the images of camera C and C′, respectively. Then u and u′ are related by the Fundamental Matrix F as:

u^{T}Fu′=0

where F˜K^{-T}EK″⁻¹.

Given the matched keypoints between 2 images from step 304 of FIG. 3, the module 106 can estimate the Fundamental Matrix F by solving a system of linear equations. If the camera's intrinsic parameters are known (via calibration), the module 106 can recover the Essential Matrix E, which is decomposed to recover R and T in step 308 of FIG. 3. Then, the module 106 uses a triangulation method to recover 3D points from pairs of matched keypoints in the 2D images.

In some embodiments, the missing geometry sections can be filled in using, e.g., depth points from the ‘Monocular SLAM’ concept as described in U.S. patent application Ser. No. 15/638,278, published as U.S. Patent Application Publication No. 2018/0005015 (which is incorporated herein by reference), i.e., the depth points for the pixels can be derived from the triangulation. In some embodiments, the missing geometry sections can be filled in using a stereo-based 3D depth sensor, where the stereo images are used (once again) to triangulate the 3D features to estimate of the depth of the image pixels.

It should be appreciated that in some cases, traditional photogrammetry techniques take too long to capture a large number of images, calculate the corresponding HD image poses, and combine a 3D structure. The techniques described herein are more robust, fully automated, and work with objects having very little or no 2D features. In addition, traditional photogrammetry techniques cannot take images from the bottom of the object, which is a missing geometry section that needs to be filled. The techniques described herein combine the best of both worlds by being able to scan in 360 degrees rotation of the object.

It should be appreciated that the methods, systems, and techniques described herein are applicable to a wide variety of useful commercial and/or technical applications. Such applications can include, but are not limited to:
Augmented Reality/Virtual Reality, Robotics, Education, Part Inspection, E-Commerce, Social Media, Internet of Things—to capture, track, and interact with real-world objects from a scene for representation in a virtual environment, such as remote interaction with objects and/or scenes by a viewing device in another location, including any applications where there may be constraints on file size and transmission speed but a high-definition image is still capable of being rendered on the viewing device;
Live Streaming—for example, in order to live stream a 3D scene such as a sports event, a concert, a live presentation, and the like, the techniques described herein can be used to immediately send out a sparse frame to the viewing device at the remote location. As the 3D model becomes more complete, the techniques provide for adding full texture. This is similar to video applications that display a low-resolution image first while the applications download a high-definition image. Furthermore, the techniques can leverage 3D model compression to further reduce the geometric complexity and provide a seamless streaming experience;
Recording for Later ‘Replay’—the techniques can advantageously be used to store images and relative pose information (as described above) in order to replay the scene and objects at a later time. For example, the computing device can store 3D models, image data, pose data, and sparse feature point data associated with the sensor capturing, e.g., a video of the scene and objects in the scene. Then, the viewing device 112 can later receive this information and recreate the entire video using the models, images, pose data and feature point data.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more specialized processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A computerized method of enhancing depth sensor-based 3D geometry reconstruction with photogrammetry, the method comprising:
capturing, by a 3D sensor coupled to a computing device, one or more 3D scans of a physical object, including related pose information of the physical object, and one or more HD images corresponding to each 3D scan;
for each 3D scan:
generating, by the computing device, an initial 3D model of the physical object using the 3D scan, the initial 3D model having one or more missing sections;
detecting, by the computing device, the one or more missing sections in a 3D point cloud associated with the initial 3D model;
projecting, by the computing device, the one or more missing sections in the 3D point cloud to a corresponding HD image for the 3D scan;
generating, by the computing device, one or more image segments of the corresponding HD image that match the one or more missing sections in the 3D point cloud;
generating, by the computing device, a 3D point cloud structure for each of the one or more image segments of the corresponding HD image; and
merging, by the computing device, the initial 3D model and the generated 3D point cloud structures to generate a final 3D model with the one or more missing sections filled in.

2. A system for enhancing depth sensor-based 3D geometry reconstruction with photogrammetry, the system comprising:
a 3D sensor that captures one or more 3D scans of a physical object, including related pose information of the physical object, and one or more HD images corresponding to each 3D scan; and
a computing device coupled to the 3D sensor that, for each 3D scan:
generates an initial 3D model of the physical object using the 3D scan, the initial 3D model having one or more missing sections;
detects the one or more missing sections in a 3D point cloud associated with the initial 3D model;
projects the one or more missing sections in the 3D point cloud to a corresponding HD image for the 3D scan;
generates one or more image segments of the corresponding HD image that match the one or more missing sections in the 3D point cloud;
generates a 3D point cloud structure for each of the one or more image segments of the corresponding HD image; and
merges the initial 3D model and the generated 3D point cloud structures to generate a final 3D model with the one or more missing sections filled in.
